(19) United States
(12) Patent Application Publication
(10) Pub. No.: US 2025/0229601 A1
(43) Pub. Date: Jul. 17, 2025

(54) METHOD OF DIRECTING AND CONTROLLING OUTLET AIRFLOW

(71) Applicant: GM GLOBAL TECHNOLOGY OPERATIONS LLC, Detroit, MI (US)

(72) Inventors: Tyler C Hanson, Clawson, MI (US); Cameron Gregory LaCourt, Royal Oak, MI (US)

(73) Assignee: GM GLOBAL TECHNOLOGY OPERATIONS LLC, Detroit, MI (US)

(21) Appl. No.: 18/413,675

(22) Filed: Jan. 16, 2024

(51) Int. Cl. B60N 2/56; B60N 2/00

(52) U.S. Cl. CPC B60H 1/00742; B60H 1/00828; B60H 1/00871; B60H 1/00971; B60N 2/0027

(57) ABSTRACT

In exemplary embodiments, methods and systems are provided for controlling airflow of a climate control system of a vehicle. In one embodiment, a system is provided that includes one or more sensors and a processor. The one or more sensors are configured to obtain sensor data pertaining to a climate control system of a vehicle. The processor is coupled to the one or more sensors, and is configured to at least facilitate dynamically adjusting control of airflow of the climate control system toward one or more locations inside a cabin of the vehicle, based on the sensor data.

### INTRODUCTION

The technical field generally relates to vehicles and, more specifically, to methods and systems for directing and controlling outlet airflow for climate control systems for vehicles.

Many vehicles today have climate control systems, such as one or more heating, ventilation, and air conditioning (HVAC) systems. However, existing techniques may not always provide optimal control of airflow the HVAC under certain conditions.

Accordingly, it is desirable to provide improved methods and systems for directing and controlling airflow of climate control systems, such as HVAC systems, of a vehicle. Furthermore, other desirable features and characteristics of the present disclosure will become apparent from the subsequent detailed description and the appended claims, taken in conjunction with the accompanying drawings and the foregoing technical field and background.

### SUMMARY

In accordance with an exemplary embodiment, a method is provided that includes: obtaining sensor data via one or more sensors of a vehicle pertaining to a climate control system of the vehicle; and dynamically adjusting control of airflow of the climate control system toward one or more locations inside a cabin of the vehicle, via a processor of the vehicle, based on the sensor data.

Also in an exemplary embodiment, the sensor data pertains to particular seats of the vehicle that are each occupied by one or more respective occupants; and the step of dynamically adjusting the control of the airflow includes dynamically adjusting the control of the airflow from an outlet based on the particular seats that are occupied by the one or more respective occupants.

Also in an exemplary embodiment, the sensor data further pertains to respective seating positions, within the particular seats, of the respective occupants; and the step of dynamically adjusting the control of the airflow includes dynamically adjusting the control of the airflow based also on the seating positions of the respective occupants.

Also in an exemplary embodiment, the sensor data further pertains to locations of a plurality of points or regions corresponding to a plurality of different body parts of the respective occupants; and the step of dynamically adjusting the control of the airflow includes dynamically adjusting the control of the airflow based also on the plurality of points or regions associated with the plurality of different body parts of the respective occupants.

Also in an exemplary embodiment, the plurality of points or regions include, for each of the respective occupants: a first point or region associated with a head or face of the occupant; a second point or region associated with a torso of the occupant; and a third point or region associated with a hip of the occupant.

Also in an exemplary embodiment, the method further includes obtaining, from a computer memory, previously stored airflow directional settings for each of the respective occupants based on user profiles in the vehicle; wherein the step of dynamically adjusting the control of the airflow includes dynamically adjusting the control of the airflow based on the particular seats that are occupied by the respective occupants and the respective seating positions thereof, in combination with the previously stored airflow directional settings of the respective occupants.

Also in an exemplary embodiment, the previously stored airflow directional settings include, for each occupant, a preference as to having airflow directed toward or away from one or more body parts of the occupant.

Also in an exemplary embodiment, the method further includes: obtaining, via one or more input sensors, user inputs from one or more of the respective occupants; wherein the step of dynamically adjusting the control of the airflow includes dynamically adjusting the control of the airflow based also on the user inputs.

Also in an exemplary embodiments, the sensor data further includes temperature data as to a temperature of one or more surfaces inside the vehicle; and the step of dynamically adjusting the control of the airflow includes dynamically adjusting the control of the airflow toward one or more of the surfaces based on a respective temperature thereof from the sensor data.

In another exemplary embodiment, a system is provided that includes one or more sensors and a processor. The one or more sensors are configured to obtain sensor data pertaining to a climate control system of a vehicle. The processor is coupled to the one or more sensors, and is configured to at least facilitate dynamically adjusting control of airflow of the climate control system toward one or more locations inside a cabin of the vehicle, based on the sensor data.

Also in an exemplary embodiment, the one or more sensors are configured to obtain the sensor data pertaining to particular seats of the vehicle that are each occupied by one or more respective occupants; and the processor is further configured to at least facilitate dynamically adjusting the control of the airflow from an outlet based on the particular seats that are occupied by the one or more respective occupants.

Also in an exemplary embodiment, the one or more sensors are configured to obtain the sensor data pertaining to respective seating positions, within the particular seats, of the respective occupants; and the processor is further configured to at least facilitate dynamically adjusting the control of the airflow based also on the seating positions of the respective occupants.

Also in an exemplary embodiment, the one or more sensors are configured to obtain the sensor data pertaining to locations of a plurality of points or regions corresponding to a plurality of different body parts of the respective occupants; and the processor is further configured to at least facilitate dynamically adjusting the control of the airflow based also on the plurality of points or regions associated with the plurality of different body parts of the respective occupants.

Also in an exemplary embodiment, the plurality of points or regions include, for each of the respective occupants: a first point or region associated with a head or face of the occupant; a second point or region associated with a torso of the occupant; and a third point or region associated with a hip of the occupant.

Also in an exemplary embodiment, the system further includes a non-transitory computer readable storage medium configured to store previously stored airflow directional settings for each of the respective occupants based on user profiles in the vehicle; and the processor is further configured to at least facilitate dynamically adjusting the control of the airflow based on the particular seats that are occupied by the respective occupants and the respective seating positions thereof, in combination with the previously stored airflow directional settings of the respective occupants.

Also in an exemplary embodiment, the previously stored airflow directional settings include, for each occupant, a preference as to having airflow directed toward or away from one or more body parts of the occupant.

Also in an exemplary embodiment, the one or more sensors include one or more input sensor configured to obtain user inputs from one or more of the respective occupants; and the processor is further configured to at least facilitate dynamically adjusting the control of the airflow based also on the user inputs.

Also in an exemplary embodiment, the one or more sensors include one or more temperature sensors configured to obtain the sensor data as to a temperature of one or more surfaces inside the vehicle; and the processor is further configured to at least facilitate dynamically adjusting the control of the airflow toward one or more of the surfaces based on a respective temperature thereof from the sensor data.

In another exemplary embodiment, a vehicle is provided that includes a climate control system; one or more sensors; and a processor. The one or more sensors are configured to obtain sensor data pertaining to the climate control system. The processor is coupled to the one or more sensors, and is configured to at least facilitate dynamically adjusting control of airflow of the climate control system toward one or more locations inside a cabin of the vehicle, based on the sensor data.

Also in an exemplary embodiment, the one or more sensors are configured to obtain the sensor data pertaining to particular seats of the vehicle that are each occupied by one or more respective occupants in addition to respective seating positions, within the particular seats, of the respective occupants; and the processor is further configured to at least facilitate dynamically adjusting the control of the airflow from an outlet based on the particular seats that are occupied by the one or more respective occupants in addition to respective seating positions, within the particular seats, of the respective occupants.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a climate control system and a control system for directing and controlling airflow of the climate control system, in accordance with an exemplary embodiment;

FIG. 2 is a flowchart of process for directing and controlling airflow of a climate control system of a vehicle, and that can be implemented in connection with the vehicle of FIG. 1, including the climate control system and the control system of FIG. 1, and components thereof, in accordance with exemplary embodiments; and

FIGS. 3, 4, 5A-5E, 6A-6C, and 7A-7C depict different implementations of the process of FIG. 2, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

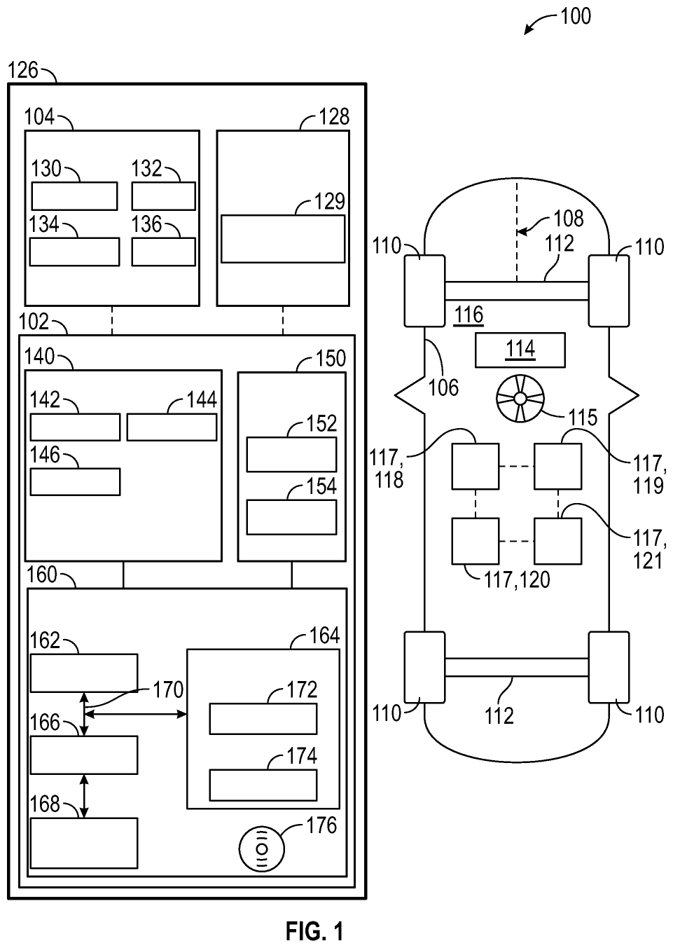

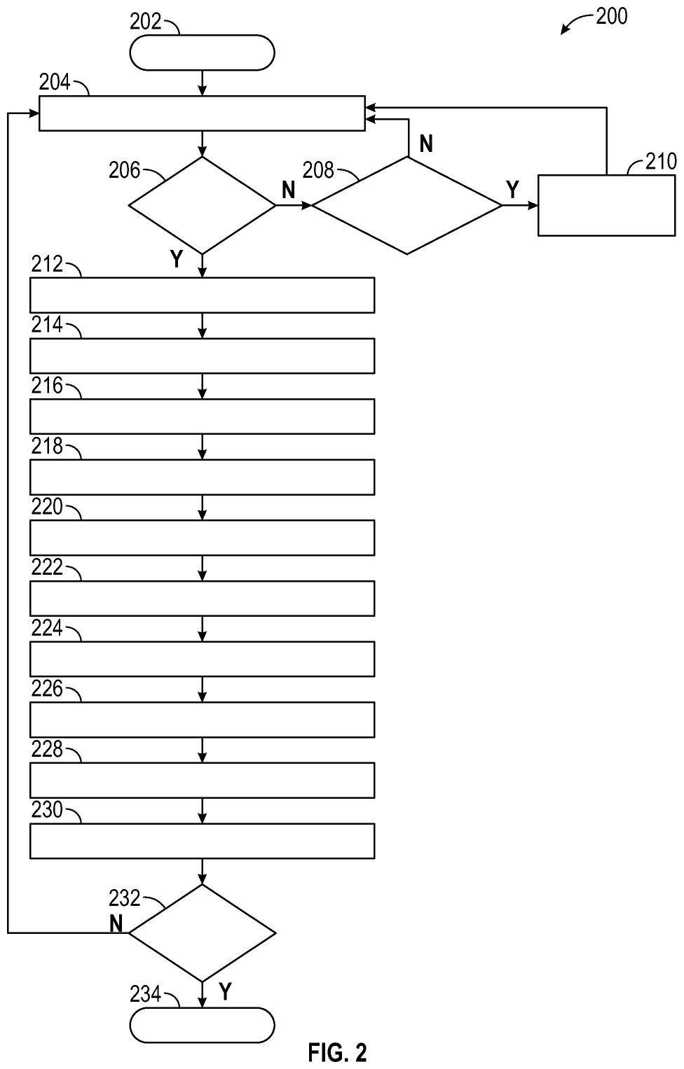

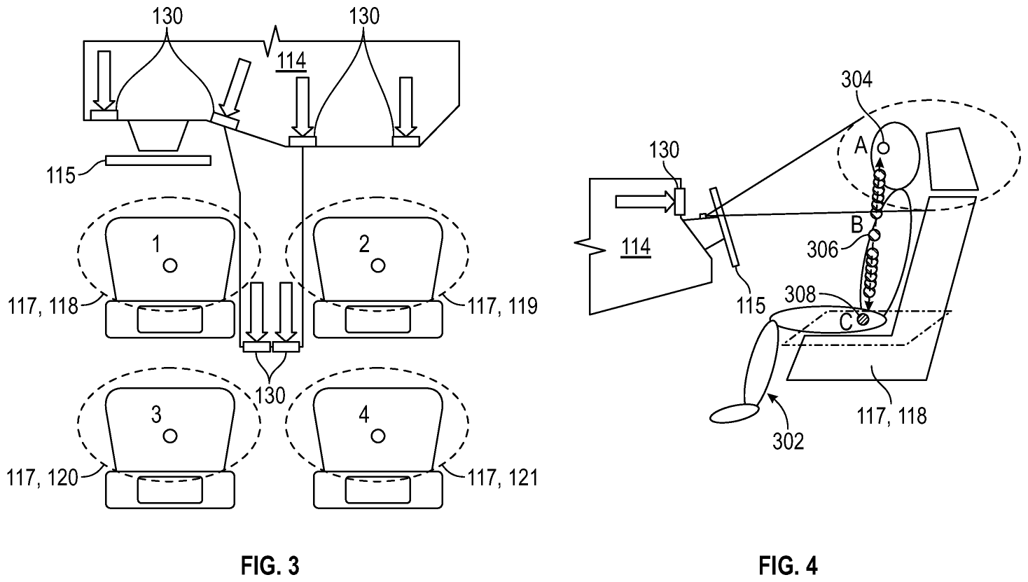

FIG. 1 illustrates a vehicle 100, according to an exemplary embodiment. As described in greater detail further below, the vehicle 100 includes a climate control system 104 and a control system 102 for controlling the direction and flow of air from the climate control system 104 based on passenger positioning within the vehicle 100, as described in greater detail further below in connection with the vehicle 100 of FIG. 1 as well as the process 200 of FIG. 2 and the implementations of FIGS. 3, 4, 5A-5E, 6A-6C, and 7A-7C.

In various embodiments, the vehicle 100 includes an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, such as aircraft, spacecraft, watercraft, and so on, and/or one or more other types of mobile platforms (e.g., a robot and/or other mobile platform).

The vehicle 100 includes a body 106 that is arranged on a chassis 108. The body 106 substantially encloses other components of the vehicle 100. The body 106 and the chassis 108 may jointly form a frame. The vehicle 100 also includes a plurality of wheels 110. The wheels 110 are each rotationally coupled to the chassis 108 near a respective corner of the body 106 to facilitate movement of the vehicle 100 via axles 112. In one embodiment, the vehicle 100 includes four wheels 110 and two axles 112, although this may vary in other embodiments (for example for trucks and certain other vehicles).

As depicted in FIG. 1, in various embodiments the vehicle 100 also includes a front dash 114 and steering wheel 115, among various other components.

Also as depicted in FIG. 1, the vehicle 100 includes a cabin 116 that is defined inside the body 106, and in which passengers are located when occupied inside the vehicle 100. As depicted in FIG. 1, in various embodiments, the vehicle 100 also includes various passenger seats 117, including a driver seat 118, a front row passenger seat 119, one or more driver side rear seats 120, and one or more passenger side rear seats 121. It will be appreciated that the vehicle 100 may include any number of different seats 117, including front and rear seats.

In various embodiments, the drive system 128 is mounted on the chassis 108, and drives the wheels 110, for example via the axles 112. In various embodiments, the drive system 128 comprises a propulsion system that includes a motor 129 (e.g., an internal combustion engine and/or an electric motor/generator, coupled with a transmission thereof). In certain embodiments, the drive system 128 and/or associated systems include or are coupled to the above-referenced steering wheel 115, and also in various embodiments one or more other components (such as, by way of an accelerator pedal, brake pedal, and the like) that receive inputs from a driver of the vehicle 100. In certain embodiments, the drive system 128 and/or associated systems may be automatically controlled via the control system 102 (e.g., for an autonomous vehicle).

In various embodiments, the climate control system 104 provides climate control, including heating and cooling, for the vehicle 100 and/or for components thereof. In certain embodiments, the climate control system 104 comprises a heating, ventilation, and air conditioning (HVAC) system for the vehicle 100.

As depicted in FIG. 1, in various embodiments the climate control system 104 includes one or more outlets 130, vanes 132, gears 134, and motors 136. In various embodiments, the outlets 130 are disposed at various locations inside the cabin 116, including the front dash 114. In various embodiments, the vanes 132 direct the flow of air from the climate control system 104 in various specific directions (e.g., up, down, left, and right, and so on) through the outlets 130, to thereby reach different respective points and/or regions inside the cabin 116. In various embodiments, the vanes 132 are adjusted in this manner via gears 134 that are controlled by one or more motors 136, that are in turn controlled by instructions provided thereto by the control system 102. Also in various embodiments, the climate control system 104 may also include various other non-depicted components, such as one or more heating and/or cooling elements, air blowers, and the like.

As depicted in FIG. 1, in various embodiments, the control system 102 includes a plurality of sensors 140 (e.g., comprising a sensor array), a display 150, and a controller 160.

In various embodiments, the sensor array 140 collects data pertaining to conditions that may affect control of the climate control system 104. In various embodiments, the sensors 140 include one or more occupant sensors 142, input sensors 144, and temperature sensors 146, among other possible sensors.

In various embodiments, the occupant sensors 142 obtain sensor data that is used for determining location and positioning of passengers within the cabin 116, including specific seats 117 in which the passengers are located, and further including different seating positions of the passengers within the different seats 117. In certain embodiments, the occupant sensors 142 comprise one or more in-cabin radar sensors of the vehicle 100. In addition, in various embodiments, the occupant sensors 142 also comprise one or more interior cameras within the vehicle, such as a camera that monitors a driver of the vehicle 100, and in certain embodiments one or more other cameras that monitor one or more passengers of the vehicle 100. In certain embodiments, the occupant sensors 142 also comprise one or more powered seating position sensors of the seats 117. In addition, in certain embodiments, one or more weight sensors may also be utilized, for example in conjunction with the seats 117, among other possible different types of occupant sensors 142.

In various embodiments, the input sensors 144 obtain user inputs from a driver and/or one or more other passengers of the vehicle 100, for example as part of a user interface for the vehicle 100. In various embodiments, the input sensors 144 obtain user inputs as to the driver's and passenger's preferences for one or more settings of the climate control system 104, such as one or more temperature settings, airflow settings, and/or user preferences as to a preferred direction of airflow (e.g., with respect to whether the driver or passenger wishes for air to be directed away from them or toward one or more particular part of the body, such as toward the head, hip, torso, or the like). In certain embodiments, the input sensors 144 obtain user inputs as part of a user interface based on the user's engagement with one or more touch screens, buttons, knobs, switches, or the like.

In various embodiments, the temperature sensors 146 obtain sensor data as to temperature values within and/or outside the vehicle 100. In certain embodiments, the temperature sensors 146 measure ambient air within the cabin 116 and/or outside the vehicle 100, including for determining whether heating or cooling is necessary or desired for the vehicle 100. Also in certain embodiments, the temperature sensors 146 may also be used to help identify one or more components inside the cabin 116 that may require heating or cooling (such as a leather or metal surface, or the like).

In certain embodiments, the display 150 is configured to provide a display that includes information as to the control of the climate control system 104 (e.g., including temperature, air flow, and/or other settings that may be inputted by the driver and/or passengers). In various embodiments, the display 150 includes an audio component 152 and a visual component 154 that interface with the driver and passengers in an audio and/or visual manner, respectively.

In various embodiments, the controller 160 is coupled to the sensors 140 and receives sensor data therefrom. In various embodiments, the controller 160 is further coupled to the climate control system 104, and in certain embodiments one or more other systems of the vehicle 100. In various embodiments, the controller 160 controls the climate control system 104 based on prior settings, driver and passenger inputs, and positioning of occupants in and within different seats 117 of the vehicle 100, including as described further below in connection with the process 200 of FIG. 2 and the implementations of FIGS. 3, 4, 5A-5E, 6A-6C, and 7A-7C.

In various embodiments, the controller 160 comprises a computer system (also referred to herein as computer system 160). In various embodiments, the controller 160 (and, in certain embodiments, the control system 102 itself) is disposed within the body 106 of the vehicle 100. In one embodiment, the control system 102 is mounted on the chassis 108. In certain embodiments, the controller 160 and/or control system 102 and/or one or more components thereof may be disposed outside the body 106, for example on a remote server, in the cloud, or the like.

It will be appreciated that the controller 160 may otherwise differ from the embodiment depicted in FIG. 1. For example, the controller 160 may be coupled to or may otherwise utilize one or more remote computer systems and/or other control systems, for example as part of one or more of the above-identified vehicle 100 devices and systems.

In the depicted embodiment, the computer system of the controller 160 includes a processor 162, a memory 164, an interface 166, a storage device 168, and a bus 170. The processor 162 performs the computation and control functions of the controller 160, and may comprise any type of processor or multiple processors, single integrated circuits such as a microprocessor, or any suitable number of integrated circuit devices and/or circuit boards working in cooperation to accomplish the functions of a processing unit. During operation, the processor 162 executes one or more programs 172 contained within the memory 164 and, as such, controls the general operation of the controller 160 and the computer system of the controller 160, generally in executing the processes described herein, such as the process 200 of FIG. 2 and the implementations of FIGS. 3, 4, 5A-5E, 6A-6C, and 7A-7C and described further below in connection therewith.

The memory 164 can be any type of suitable memory, including various types of non-transitory computer readable storage medium. In certain examples, the memory 164 is located on and/or co-located on the same computer chip as the processor 162. In the depicted embodiment, the memory 164 stores the above-referenced program 172 along with stored values 174 (e.g., look-up tables, thresholds, and/or other values with respect to control of the climate control system 104 of the vehicle 100).

The interface 166 allows communication to the computer system of the controller 160, for example from a system driver and/or another computer system, and can be implemented using any suitable method and apparatus. In one embodiment, the interface 166 obtains the various data from the sensors 140, among other possible data sources. The interface 166 can include one or more network interfaces to communicate with other systems or components. The interface 166 may also include one or more network interfaces to communicate with technicians, and/or one or more storage interfaces to connect to storage apparatuses, such as the storage device 168.

The storage device 168 can be any suitable type of storage apparatus, including various different types of direct access storage and/or other memory devices. In one exemplary embodiment, the storage device 168 comprises a program product from which memory 164 can receive a program 172 that executes one or more embodiments of one or more processes of the present disclosure, such as the steps of the process 200 of FIG. 2 and the implementations of FIGS. 3, 4, 5A-5E, 6A-6C, and 7A-7C and described further below in connection therewith. In another exemplary embodiment, the program product may be directly stored in and/or otherwise accessed by the memory 164 and/or a disk (e.g., disk 176), such as that referenced below.

The bus 170 serves to transmit programs, data, status and other information or signals between the various components of the computer system of the controller 160. The bus 170 can be any suitable physical or logical means of connecting computer systems and components. This includes, but is not limited to, direct hard-wired connections, fiber optics, infrared and wireless bus technologies. During operation, the program 172 is stored in the memory 164 and executed by the processor 162.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 162) to perform and execute the program.

FIG. 2 is a flowchart of process 200 for controlling direction and flow of a climate control system of a vehicle, in accordance with exemplary embodiments. The process 200 can be implemented in connection with the vehicle 100 of FIG. 1, including the climate control system 104 and the control system 102 of FIG. 1, and components thereof, in accordance with exemplary embodiments. The process 200 will also be described below with reference to FIGS. 3, 4, 5A-5E, 6A-6C, and 7A-7C, which depict exemplary implementations of certain steps of the process of FIG. 2 as set forth in greater detail further below.

As depicted in FIG. 2, the process 200 begins at step 202. In one embodiment, the process 200 begins when the vehicle 100 is or has been operated, for example during a current vehicle drive or when the vehicle 100 (and/or a motor 129 thereof) is started. In one embodiment, the steps of the process 200 are performed continuously once the process 200 begins.

Also in various embodiments, sensor data is obtained at step 204. In various embodiments, sensor data pertaining to the vehicle 100, including as to the climate control system 104 thereof, is obtained via the sensors 140 of FIG. 1. In certain embodiments, the sensor data of step 206 includes parameters pertaining to driver and passenger occupancy of various seats 117 including of seating positions of the driver and passengers within the seats, via the occupant sensors 142 of FIG. 1 (e.g., including in-cabin radar sensors, in-cabin cameras, powered seating position sensors, and in certain embodiments weight sensors and/or other occupant sensors). Also in various embodiments, the sensor data includes inputs from a driver and/or other passengers of the vehicle 100 as to settings for and operation of the climate control system 104 of FIG. 1 (e.g., via the input sensors 144 of FIG. 1 as part of a user interface for the vehicle 100). In addition, in certain embodiments, the sensor data also includes temperature values obtained via temperature sensors 146 of FIG. 1, such as air temperature within the cabin 116 and/or outside the vehicle 100, and also in certain embodiments a temperature of one or more specific surfaces (e.g., leather, metal, and/or other surfaces) inside the cabin 116 that are prone to get hot or cold more quickly.

In various embodiments, a determination is made as to whether any occupants are inside the cabin 116 of the vehicle 100 (step 206). In various embodiments, this determination is made by the processor 162 of FIG. 1 based on the sensor data of step 204 from one or more of the occupant sensors 142.

In various embodiments, if it is determined in step 206 that no occupants are currently within the cabin 116 of the vehicle 100, then a determination is made in step 208 as to whether climate control is needed for the vehicle. In certain embodiments, this determination is made by the processor 162 of FIG. 1 based on temperature values, such as ambient temperature outside the vehicle 100, a temperature inside the cabin 116, and in certain embodiments temperatures of one or more components or regions of the vehicle 100 that are likely to particularly hot or cold (e.g., one or more leather or metal surfaces).

In various embodiments, if it is determined in step 208 that climate control is needed, then climate control is provided at step 210. In various embodiments, heating or cooling (depending on the measured temperatures) is provided via the climate control system 104 in accordance with instructions provided by the processor 162. Also in various embodiments, the outlets 130 are adjusted to direct airflow to one or more areas that require heating or cooling the most (e.g., leather surfaces, metal surfaces, or other surfaces that may be particularly hot or cold), for example by directing the airflow to such areas by adjusting the outlets 130 and/or vanes 132 via the gears 134 and motor 136 of FIG. 1 in accordance with instructions provided by the processor 162. In various embodiments, the process then returns to step 204 with updated sensor data, and the process continues.

Conversely, if it is instead determined in step 208 that climate control is not needed (e.g., at the present point in time), then the process returns directly to step 204 without providing climate control.

With reference back to step 206, if it is determined that occupants are disposed in the vehicle 100, then a determination is made as to whether occupants are present within the seats 117 of the vehicle 100 (step 212). Specifically, in various embodiments, during step 212, the processor 162 of FIG. 1 determines which specific seats 117 have a driver or other passengers disposed thereon, based on the sensor data of step 204. In certain embodiments, the processor 162 determines whether each of the seats 118, 119, 120, and 121 (and, in certain embodiments, any additional seats 117 that may also be present within the cabin 116 of the vehicle 100) currently have a driver or passenger disposed thereon. In various embodiments, these determinations of step 212 are made by the processor 162 using sensor data provided by one or more of the occupant sensors 142 of FIG. 1, such as via one or more in-cabin radar sensors, interior cabin cameras, weight sensors of the seats 117, and so on.

With reference to FIG. 3, in accordance with an exemplary implementation, during step 212 determinations are made with respect to each of the seats 117 of the vehicle 100, for example including the driver seat 118, the front passenger seat(s) 119, driver side rear seat(s) 120, and passenger side rear seat(s) 121 (and with respect to any other seats 117 of the vehicle 100) as to whether a driver or passenger is seated in each such seat 117.

With respect back to FIG. 2, in various embodiments, occupant seating positions are also identified (step 214). Specifically, in various embodiments, during step 214, the processor 162 of FIG. 1 determines how each driver and passenger are situated and seated within their respective seats 117 (e.g., including seating positions, such as whether a driver or passenger is seated upright, slouched forward or back, and so on), based on the sensor data of step 204. In various embodiments, these determinations of step 214 are made by the processor 162 using sensor data provided by one or more of the occupant sensors 142 of FIG. 1, such as via one or powered seating position sensors of the seats 117, and/or interior cabin cameras, and so on.

Also in various embodiments, a first location is determined for each of the driver and passengers of the vehicle 100 (step 216). In certain embodiments, the first location (also referred to as “Point A”) refers to a head or face of the occupant, or a region in proximity thereto. In certain embodiments, the first location (i.e., Point A) is determined for the driver and each passenger of the vehicle 100 via the processor 162 using sensor data from one or more of the occupant sensors 142 of the vehicle 100, such as one or more in-cabin radar sensors, interior cameras, or the like.

Also in certain embodiments, a second location is determined for each of the driver and passengers of the vehicle 100 (step 218). In certain embodiments, the second location (also referred to as “Point B”) refers to a torso, or a region in proximity thereto. In certain embodiments, the second location (i.e., Point B) is determined for the driver and each passenger of the vehicle 100 via the processor 162 using sensor data from one or more of the occupant sensors 142 of the vehicle 100, such as one or more powered seating position sensors, one or more interior cameras, or the like.

In addition, in various embodiments, a third location is determined for each of the driver and passengers of the vehicle 100 (step 220). In certain embodiments, the third location (also referred to as “Point C”) refers to a hip, or a region in proximity thereto. In certain embodiments, the third location (i.e., Point C) is determined for the driver and each passenger of the vehicle 100 via the processor 162 by calculating a midpoint between Point A and Point B as defined above. In certain embodiments, the location of Point C and/or any number of different points, body parts, and/or locations of the occupants and/or for climate control may also be determined, directly via the sensor data and/or via one or more other different calculations.

While steps 214, 216, 218, and 220 are depicted in FIG. 2 as representing separate steps, it will be appreciated that one or more of these steps could be combined and/or broken up further in certain embodiments. For example, in certain embodiments, step 214 could be interpreted as being a combined step that encompasses each of steps 216, 218, and 220, and so on, among other possible variations.

With reference to FIG. 4, in accordance with an exemplary implementation, during steps 214-220 determinations are made with respect to each of the seats 117 of the vehicle 100, as to the respective points of interest with respect to an occupant 302 of the vehicle 100. As depicted in FIG. 4, in an exemplary embodiment, determinations are made by the processor 162 of FIG. 1 with respect to the occupant 302 as to a location of the head (or face) at Point A 304, the torso at Point B 306, and the hit at point C 308. While FIG. 4 depicts a driver as the occupant in the driver seat 118, it will be appreciated that in various embodiments similar determinations are made with respect to other occupants 302 such as various other passengers in various other seats 117 of the vehicle 100.

With reference back to FIG. 2, In various embodiments, user settings are retrieved at step 222. In various embodiments, during step 222, user settings are obtained with respect to the climate control system 104, such as a user's preferences as to temperature and/or air flow and direction thereof (e.g., as to a preference for location of airflow to Point A, Point B, Point C, and/or to one or more other locations with respect to the user in various embodiments). In certain embodiments, the settings comprise previously stored airflow directional settings for each occupant as to respective preferences for airflow from the climate control system 104 to be directed toward or away from one or particular body parts (e.g., head or face, torso, hip, and so on) of the particular occupant. Also in various embodiments, the previously stored airflow directional settings are retrieved from the memory 164 of FIG. 1 (e.g., from stored values 174 therein) based on one or more current occupants of the vehicle 100 (e.g., based on an identified keyfob or mobile device associated with one or more known users of the vehicle 100, or the like).

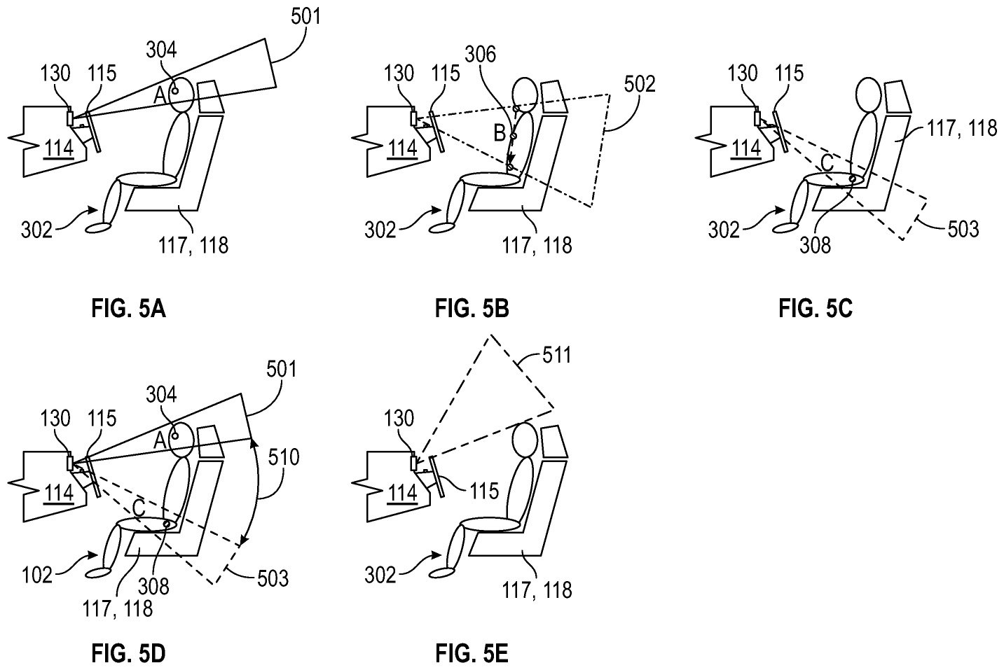

With reference to FIGS. 5A-5E, various illustrative user preferences are depicted, in accordance with exemplary implementations associated with step 222. With respect to FIG. 5A, a first exemplary implementation is provided in which airflow is directed in a direction 501 toward Point A 304, toward a head or face of the occupant 302. With respect to FIG. 5B, a second exemplary implementation is provided in which airflow is directed in a direction 502 toward Point B 306, toward a torso of the occupant 302. With respect to FIG. 5C, a third exemplary implementation is provided in which airflow is directed in a direction 503 toward Point C 308, toward a hip of the occupant 302. With respect to FIG. 5D, a fourth exemplary implementation is provided in which airflow oscillates between direction 501 (i.e., toward Point A 304) and direction 503 (i.e., toward Point C 503), as represented by oscillation 510 in FIG. 5D. Finally, with respect to FIG. 5E, a fifth exemplary implementation is provided in which airflow is directed in a direction 511 away from the occupant 302. It will be appreciated that in certain embodiments one or more other types of user preferences may also be utilized. Moreover, it will be appreciated that while FIGS. 5A-5E depict a driver as the occupant in the driver seat 118, it will be appreciated that in various embodiments similar determinations are made with respect to other occupants 302 such as various other passengers in various other seats 117 of the vehicle 100.

With reference back to FIG. 2, also in various embodiments, user inputs are determined (step 224). In various embodiments, the user inputs that are obtained include user requests and preferences that are made within the current iteration of the process 200 (i.e., within the current vehicle drive) with respect to the climate control system 104, including any temperature settings and/or air flow settings entered by the user, and further including any preferences for air to be directed to any of Points A, B, or C with respect to the user, or to be directed away from the user, among other possible user inputs (for example, which may include, among other possible inputs, the implementations of FIGS. 5A-5E as described above). In various embodiments, the user inputs are determined via the input sensors 144 of FIG. 1 as part of a user interface and/or via the processor 162 of FIG. 1 using values obtained via the input sensors 144.

In various embodiments, the outlets 130 are activated and oriented (step 226). Specifically, in various embodiments, the outlets 130 are activated and oriented such as to control and direct airflow consistent with the occupancy of the driver and passengers in and within the various seats 117 (e.g., as determined in steps 212-220) as well as with the settings and user inputs (e.g., as determined in steps 226). For example, in various embodiments, the settings and/or user inputs for each occupant 302 are matched with the specific seat 117 in which each occupant 302 is located, such that the desired comfort is attained for each occupant 302. For example, if a driver in the driver seat 118 prefers the airflow configuration of FIG. 5A while a passenger in the front passenger seat 119 prefers the airflow configuration of FIG. 5B, then in various embodiments then airflow will be directed toward Point A 304 of the driver via one or more first outlet(s) 130, while airflow will also be directed toward Point B 306 of the front passengers via one or more second outlet(s) consistent with these different preferences, and so on. In various embodiments, during step 226, the activation and orientation of the outlets 130 is based on a mapping of the different seats 117 that are occupied, in combination with the settings (including airflow directional settings) of the respective occupants of the various seats 117.

In addition, during step 226, in certain embodiments airflow may be reduced or shut off to unoccupied seats 117 in certain embodiments (for example to save energy) or may be re-directed toward occupied seats 117 in certain other embodiments (for example, to further enhance comfort of the occupants 302 in the vehicle 100).

In various embodiments, the control of step 226 is performed by adjusting the outlets 130 and/or vanes 132 via the gears 134 and motor 136 of FIG. 1 in accordance with instructions provided by the processor 162.

With reference back to FIG. 2, in various embodiments, the control of the outlets 130 in this manner is dynamically maintained throughout the entirety of the vehicle drive, as set forth below with reference to steps 228 and 230. Specifically, in various embodiments, as additional sensor data is obtained (e.g., in new iterations of step 204 that are continuously performed), additional calculations are performed as to the location and position and the driver and passengers (e.g., in new iterations of steps 206-220 that are continuously performed), and additional user inputs are received (e.g., in new iterations of step 224 that are also continuously performed), then the activation and orientation of outlets (e.g. of step 226) are continuously updated and adjusted in a dynamic manner with respect to both (a) dynamic control and direction of flow selectively toward specific seats 117 (step 228) and (b) dynamic control and direction of flow selectively toward specific points and/or regions, such as to Point A, Point B, and Point C, and so on as described above (step 230). For example, in various embodiments, when a particular occupant changes seating position within his or her seat, the direction of the airflow will be adjusted accordingly based on the change in seating position (e.g., to reach the desired target point that corresponds to the new position of the occupant). Likewise, also in various embodiments, when an occupant changes user inputs, the airflow will also be adjusted in order to achieve the changes requested via the user inputs, and so on.

In various embodiments, a determination is made as to whether the current drive cycle is over (step 232). In various embodiments, this determination is made by the processor 162 of FIG. 1 (e.g., as to whether the vehicle 100 has reached its destination, and/or as to whether the current vehicle drive is complete, or the like).

In various embodiments, if it is determined that the current drive cycle is not over, then the process returns to step 204, as sensor data continues to be collected. In various embodiments, the process 200 continues and repeats until a determination is made during an iteration of step 232 that the current drive cycle is over.

In various embodiments, once it is determined that the current drive cycle is over, the process terminates at step 234.

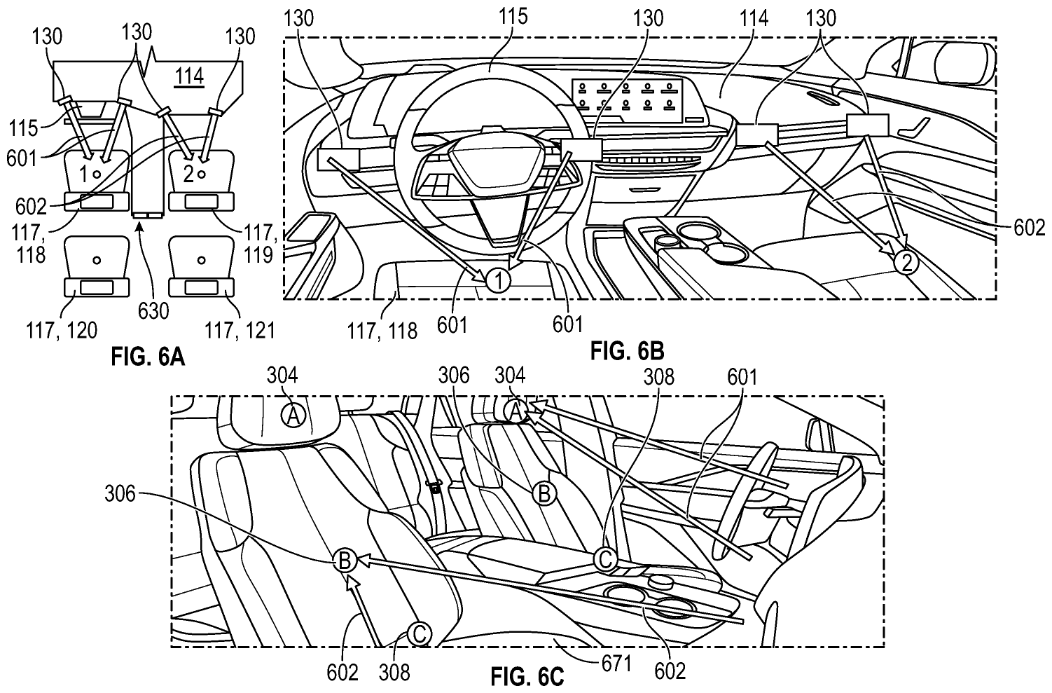

With reference to FIGS. 6A-C and 7A-7C, additional implementations are provided for the process 200, in accordance with exemplary embodiments.

With reference first to FIGS. 6A-6C, an exemplary implementation is provided with respect to the activation and orientation of the outlets in step 226 of FIG. 2. Specifically, in the exemplary implementation of FIGS. 6A-6C, there is a driver in the driver seat 118 and a passenger in the front passenger seat 119, but no passengers in any of the rear seats 120, 121 (as depicted in FIG. 6A).

Also as shown in FIG. 6A, in an exemplary embodiment, first airflow streams 601 are provided by certain outlets 130 toward the driver seat 118, while second airflow streams 602 are provided by certain other outlets 130 toward the front passenger seat 119. These first and second airflow streams 601, 602 are also illustrated in FIG. 6B in accordance with an exemplary embodiment. In addition, in various embodiments as depicted in FIG. 6A, airflow is cut off to the rear seats 120, 121, as depicted via airflow cutoff point 630.

With reference to FIG. 6C, also in an exemplary embodiment of this implementation of FIGS. 6A-6C, the first airflow streams 601 are directed toward Point A 304 of the driver seat 118, whereas the second airflow streams 602 are directed toward Point B 306 of the front passenger seat 119. In various embodiments, this corresponds to an implementation in which the driver has requested or indicated a preference with airflow toward the driver's head or face (i.e., corresponding to the Point A 304), whereas the front passenger has requested or indicated a preference with airflow toward the front passenger's torso (i.e., corresponding to the Point B 306). It will be appreciated that the directions of airflow of FIGS. 6A-6C would differ based on different configurations of occupants within the seats 117 of the vehicle 100, and also based on different preferences of the different occupants, and so on.

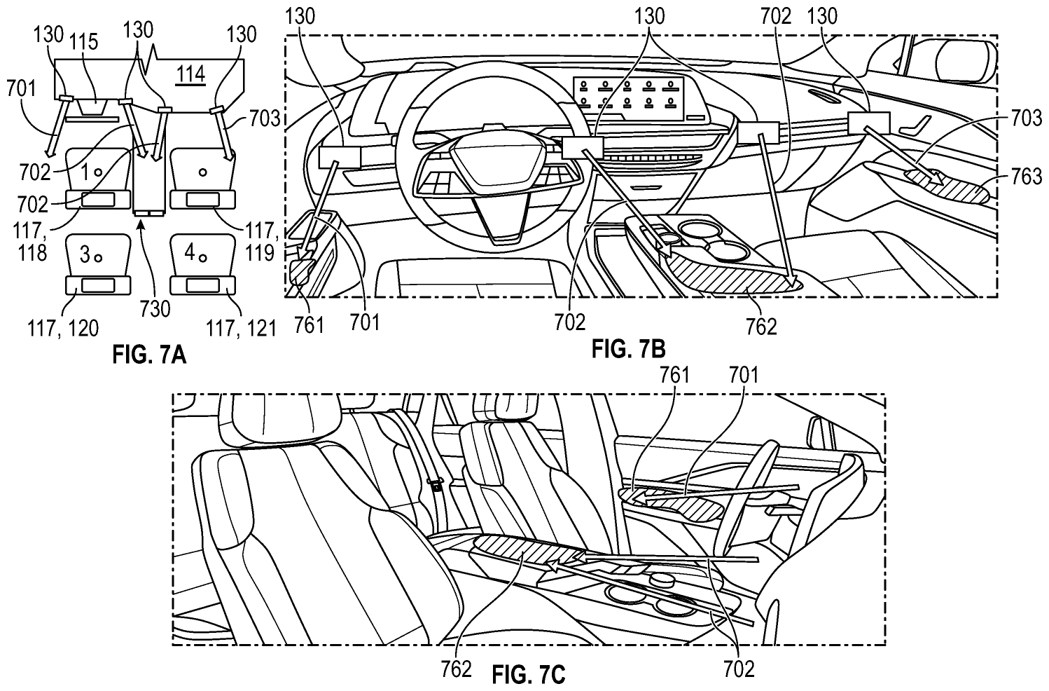

With reference next FIGS. 7A-7C, an exemplary implementation is provided with respect to the heating and cooling of specific surfaces of the vehicle 100, for example in accordance with an embodiment of step 210 in which the vehicle 100 is unoccupied but has been turned on (e.g., as part of a vehicle 100 warm-up or cool-down). Specifically, in the exemplary implementation of FIGS. 7A-7C, there are no occupants in the vehicle 100 (as depicted in FIG. 7A).

Also as shown in FIG. 7A, in an exemplary embodiment, a first airflow stream 701 is provided by certain outlets 130 to a driver side of the front row of the vehicle 100, while second airflow streams 702 are provided by certain other outlets 130 in the middle of the front row of the vehicle 100, and a third airflow stream 703 is provided by certain other different outlets toward a passenger side of the front row of the vehicle 100. These first, second, and third airflow streams 701, 702, and 703 are also illustrated in FIG. 7B in accordance with an exemplary embodiment. In addition, in various embodiments as depicted in FIG. 7A, airflow is cut off to the rear seats 120, 121, as depicted via airflow cutoff point 730.

With continued reference to FIG. 7B as well as to FIG. 7C, in this exemplary implementation: (a) the first airflow stream 701 is directed toward a first region 761 proximate the driver's door; (b) the second airflow streams 702 are directed toward a second region 762 in between the driver seat 118 and the front passenger seat 119; and (c) the third airflow stream 703 is directed toward a third region 763 proximate the front passenger's door. In various embodiments, the first region 761, second region 762, and third region 763 each represent respective vehicle components and/or areas that are likely to be particularly sensitive to hot or cold ambient weather conditions (e.g., that may include or correspond to a leather, metal, and/or other surface that is likely to be too hot or too cold depending on ambient air conditions, and so on).

Accordingly, in various embodiments, systems and methods are provided for directing and controlling airflow of a climate control system 104 of a vehicle 100. In various embodiments, the airflow is directed and controlled in a dynamic manner based on the driver's and passenger's positioning within the vehicle 100 as well as within the seats 117 of the vehicle 100, and in various embodiments also in combination with user preferences and settings. In various embodiments, this may provide for enhanced comfort for the driver and passengers of the vehicle 100. In addition, in various embodiments, this may also provide for energy savings as well as for a lessened workload for the driver and passengers of the vehicle 100, thereby potentially resulting in a more focused driver, and so on.

It will be appreciated that the systems, vehicles, and methods may vary from those depicted in the Figures and described herein. For example, the vehicle 100 of FIG. 1, the control system 102, and climate control system 104 thereof, and/or components thereof of FIG. 1 may vary in different embodiments. It will similarly be appreciated that the steps of the process 200 may differ from that depicted in FIG. 2, and/or that various steps of the process 200 may occur concurrently and/or in a different order than that depicted in FIG. 2. It will also be appreciated that the implementations of FIGS. 3, 4, 5A-5E, 6A-6C, and 7A-7C may also vary in different embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
obtaining sensor data via one or more sensors of a vehicle pertaining to a climate control system of the vehicle; and
dynamically adjusting control of airflow of the climate control system toward one or more locations inside a cabin of the vehicle, via a processor of the vehicle, based on the sensor data.

2. The method of claim 1, wherein:
the sensor data pertains to particular seats of the vehicle that are each occupied by one or more respective occupants; and
the step of dynamically adjusting the control of the airflow comprises dynamically adjusting the control of the airflow from an outlet based on the particular seats that are occupied by the one or more respective occupants.

3. The method of claim 2, wherein:
the sensor data further pertains to respective seating positions, within the particular seats, of the respective occupants; and
the step of dynamically adjusting the control of the airflow comprises dynamically adjusting the control of the airflow based also on the seating positions of the respective occupants.

4. The method of claim 2, wherein:
the sensor data further pertains to locations of a plurality of points or regions corresponding to a plurality of different body parts of the respective occupants; and
the step of dynamically adjusting the control of the airflow comprises dynamically adjusting the control of the airflow based also on the plurality of points or regions associated with the plurality of different body parts of the respective occupants.

5. The method of claim 4, wherein the plurality of points or regions comprise, for each of the respective occupants:
a first point or region associated with a head or face of the occupant;
a second point or region associated with a torso of the occupant; and
a third point or region associated with a hip of the occupant.

6. The method of claim 3, further comprising:
obtaining, from a computer memory, previously stored airflow directional settings for each of the respective occupants based on user profiles in the vehicle;
wherein the step of dynamically adjusting the control of the airflow comprises dynamically adjusting the control of the airflow based on the particular seats that are occupied by the respective occupants and the respective seating positions thereof, in combination with the previously stored airflow directional settings of the respective occupants.

7. The method of claim 6, wherein the previously stored airflow directional settings comprise, for each occupant, a preference as to having airflow directed toward or away from one or more body parts of the occupant.

8. The method of claim 3, further comprising:
obtaining, via one or more input sensors, user inputs from one or more of the respective occupants;
wherein the step of dynamically adjusting the control of the airflow comprises dynamically adjusting the control of the airflow based also on the user inputs.

9. The method of claim 1, wherein:
the sensor data further includes temperature data as to a temperature of one or more surfaces inside the vehicle;
wherein the step of dynamically adjusting the control of the airflow comprises dynamically adjusting the control of the airflow toward one or more of the surfaces based on a respective temperature thereof from the sensor data.

10. The method of claim 1, wherein the dynamically adjusting of the control is performed during vehicle warm up and cool down, allowing flexibility to achieve system level warm up and cool down targets by allowing specific airflow patterns by manipulating outlet direction to help adjust cabin temperature of the vehicle more efficiently.

11. A system comprising:
one or more sensors configured to obtain sensor data pertaining to a climate control system of a vehicle; and
a processor that is coupled to the one or more sensors and that is configured to at least facilitate dynamically adjusting control of airflow of the climate control system toward one or more locations inside a cabin of the vehicle, based on the sensor data.

12. The system of claim 11, wherein:
the one or more sensors are configured to obtain the sensor data pertaining to particular seats of the vehicle that are each occupied by one or more respective occupants; and
the processor is further configured to at least facilitate dynamically adjusting the control of the airflow from an outlet based on the particular seats that are occupied by the one or more respective occupants.

13. The system of claim 12, wherein:
the one or more sensors are configured to obtain the sensor data pertaining to respective seating positions, within the particular seats, of the respective occupants; and
the processor is further configured to at least facilitate dynamically adjusting the control of the airflow based also on the seating positions of the respective occupants.

14. The system of claim 12, wherein:
the one or more sensors are configured to obtain the sensor data pertaining to locations of a plurality of points or regions corresponding to a plurality of different body parts of the respective occupants; and
the processor is further configured to at least facilitate dynamically adjusting the control of the airflow based also on the plurality of points or regions associated with the plurality of different body parts of the respective occupants.

15. The system of claim 14, wherein the plurality of points or regions comprise, for each of the respective occupants:
a first point or region associated with a head or face of the occupant;
a second point or region associated with a torso of the occupant; and
a third point or region associated with a hip of the occupant.

16. The system of claim 13, further comprising:
a non-transitory computer readable storage medium configured to store previously stored airflow directional settings for each of the respective occupants based on user profiles in the vehicle;
wherein the processor is further configured to at least facilitate dynamically adjusting the control of the airflow based on the particular seats that are occupied by the respective occupants and the respective seating positions thereof, in combination with the previously stored airflow directional settings of the respective occupants; and
wherein the previously stored airflow directional settings comprise, for each occupant, a preference as to having airflow directed toward or away from one or more body parts of the occupant.

17. The system of claim 13, wherein:
the one or more sensors comprise one or more input sensor configured to obtain user inputs from one or more of the respective occupants;
wherein the processor is further configured to at least facilitate dynamically adjusting the control of the airflow based also on the user inputs.

18. The system of claim 10, wherein:
the one or more sensors comprise one or more temperature sensors configured to obtain the sensor data as to a temperature of one or more surfaces inside the vehicle; and
the processor is further configured to at least facilitate dynamically adjusting the control of the airflow toward one or more of the surfaces based on a respective temperature thereof from the sensor data.

19. A vehicle comprising:
a climate control system:
one or more sensors configured to obtain sensor data pertaining to the climate control system; and
a processor that is coupled to the one or more sensors and that is configured to at least facilitate dynamically adjusting control of airflow of the climate control system toward one or more locations inside a cabin of the vehicle, based on the sensor data.

20. The vehicle of claim 19, wherein:
the one or more sensors are configured to obtain the sensor data pertaining to particular seats of the vehicle that are each occupied by one or more respective occupants in addition to respective seating positions, within the particular seats, of the respective occupants; and
the processor is further configured to at least facilitate dynamically adjusting the control of the airflow from an outlet based on the particular seats that are occupied by the one or more respective occupants in addition to respective seating positions, within the particular seats, of the respective occupants.
